(19) United States
(12) Patent Application Publication
(10) Pub. No.: US 2006/0072432 A1
(43) Pub. Date: Apr. 6, 2006

(54) Optical disc recycling method and recycling system

(76) Inventor: Tomoaki Ito, Osaka-shi (JP)

Correspondence Address: WOOD, PHILLIPS, KATZ, CLARK & MORTIMER, 500 W. MADISON STREET, SUITE 3800, CHICAGO, IL, 60661, US

(21) Appl. No.: 10/521,645

(22) PCT Filed: Jul. 22, 2003
(86) PCT No.: PCT/JP03/09296

§ 371 Date: Jan. 13, 2005

(30) Foreign Application Priority Data
Jul. 24, 2002 (JP) 2002-214834

(51) Int. Cl. G11B 7/26

(52) U.S. Cl. 369/272.1

(57) ABSTRACT

A raw material supplier manufactures raw material for a plastic substrate by means of a raw material manufacturing device. A disk presser manufactures a substrate from the raw material by means of an optical disk manufacturing device, manufactures an optical disk by laminating the substrate sequentially with the recording layer and the reflecting layer, and records predetermined information on the disk by means of an information recording device. The disk presser recovers a pure and lucent plastic substrate from a disk fallen into disuse, so as to supply the substrate to the raw material supplier.

### TECHNICAL FIELD

The present invention relates to a method for recycling an optical disk in the broad sense of the term including not only, for example, a write once read many optical disk that is referred to as CD-R and/or a read-only optical disk that is referred to as CD-ROM but also a so-called magnetic optical disk, and further, relates to a recycling system thereof.

### BACKGROUND ART

In present years, various optical disks such as so-called magnetic optical disks as well as write once read many optical disks that are referred to as CD-Rs and/or read-only optical disks that are referred to as CD-ROMs are used in diverse field such as computer program developments or secret records like company's accounts and the like.

An optical disk has a plastic substrate sequentially laminated with a recording layer and a reflecting layer. Raw material of the plastic substrate such as polycarbonate is supplied from a raw material supplier to an optical disk presser, who forms the plastic substrate from the raw material and laminates the substrate sequentially with the recording layer and the reflecting layer.

The optical disks, on which predetermined information such as music information, game information, and picture information are recorded by the disk presser, are shipped as CD-ROMs and the like to predetermined shops such as CD shops and personal computer shops. The optical disks may also be shipped from the disk presser as CD-Rs and the like with no information recorded thereon to ordinary traders such as computer program developers, who will record predetermined information such as computer programs and company's account information on the disks.

When information is recorded on the optical disk, recording of incomplete or miswritten information is frequently caused. Such an optical disk falls into disuse for a disk presser or an ordinary trader, however a plastic substrate of the disused optical disk can be used by a raw material supplier, so it is likely to need to recycle the disused optical disk.

However, since important data is recorded on the optical disk, confidential matter may be leaked out unless recorded data is destroyed or put out of read in advance before the recycle of the disk.

Consequently, methods for destroying data of an optical disk or putting it out of read have been conventionally proposed as follows:

1. A method for destroying the data recorded on an optical disk by application of a coating material for destruction of data to a recording surface of the disk, or by irradiation of a high-power laser beam to the disk. (JP 9-97432A)

2. A method for putting the data out of read by application of heat between 80 and 150 degree centigrade to cause a thermal change around a data pit. (JP 10-214424A)

3. A method for putting the data out of read by adhering an adhesive tape on a surface of a protecting layer provided on the upper surface of a reflecting layer, which tape is peeled off so as to separate the reflecting layer from a light-adsorbing layer (viz. organic layer), paying attention to a slightly poor adhesion of the reflecting layer with the light-adsorbing layer constituting the recording layer. (JP 5-166231A)

4. A method for putting the data out of read by abrading the recording layer and the reflecting layer by an abrasive body with supplying water, the abrasive body made by forming an abrasive sheet into a cylindrical shape, the abrasive sheet made by hot-pressing a supporting body and a mixture of an abrasive grain and an adhesive bond. (JP 5-210873A)

However, according to the methods 1 and 2, since the disk after destroying its disk data is a mixture of a lucent plastic substrate, a light-adsorbent, and a metal film such as aluminum and gold that constitute the reflecting layer, a disposal problem remains resulting from no separation of plastic from metal in the case of disposal as a waste without any process. In order to reuse such an optical disk as a recycled product, it is necessary to separate at least the plastic substrate from the metal of reflecting film to be recovered by some much further measures.

According to the method 3, although the light-adsorbing layer as the recording layer is separated from the reflecting layer, the light-adsorbing layer is not separated from the plastic substrate, resulting in requiring much further separation and removal of the light-adsorbing layer from the plastic substrate in order to recycle the plastic substrate. Even if such separation and removal are not difficult for a skilled person, another separation of the light-adsorbing layer from the plastic substrate is required, resulting in, in a manner, involving a duplication of work, which is inefficient.

According to the method 4, since the disk is abraded with supplying water, it is a little tiresome to process water including powder flaked off from the disk by abrasion and to extract a precious metal in the case of the reflecting layer made of the precious metal, and besides a device using the method requires an appropriate waterproof measures at a portion of electric system, so it is also a little tiresome to manufacture the device itself.

As described above, either of the methods described above has the drawbacks in its process. Further, it is difficult to destroy data of a disk and/or put it out of read without a professional waste disposer to be ordered for the special processes, causing a problem of increasing cost for recycling the optical disk.

It is therefore an object of the present invention made in view of such problems and drawbacks described above to provide an improved method for recycling an optical disk and a recycling system thereof capable of destroying data of an optical disk with ease and certainty by a disk presser or a trader who purchases the optical disk from the disk presser, and therefore capable of reducing cost for recycling the optical disk.

### SUMMARY OF THE INVENTION

The present invention to solve the problem described above is therefore to provide a method for recycling an optical disk made of a plastic substrate sequentially laminated with a recording layer and a reflecting layer by a raw material supplier of the substrate and a disk presser who manufactures the optical disk, and optionally a trader who purchases the optical disk from the disk presser, including the steps of one selected from steps consisting of (1) procuring raw material for the substrate and (2) manufacturing the raw material by means of a raw material manufacturing device and by the raw material supplier of the substrate, manufacturing the optical disk by means of an optical disk manufacturing device and by the disk presser by forming the substrate from the raw material for the substrate and laminating the substrate sequentially with the recording layer and the reflecting layer, recording predetermined information on the optical disk by means of an information recording device and by one selected from the disk presser and the trader having purchased the disk from the presser, and recovering a pure and lucent plastic substrate without any material constituting the recording layer and the reflecting layer by means of a substrate recovery device and by one having recorded the predetermined information on the disk by abrading a disk fallen into disuse by means of an abrader from the reflecting layer side without supplying water so as to break the material away from the substrate and into powder while collecting the powder by a means for collecting powder.

According to this method, the substrate recovery device abrades an optical disk from the reflecting layer side so as to break the reflecting layer and the recording layer away from the substrate and into powder, thereby destroying data and recovering the pure substrate automatically once for all. Therefore, if and when recording incomplete or miswritten information on the disk, the disk presser and/or the trader having purchased the disk from the presser destroy the data of the disk and recover the pure substrate directly by the recovery device with ease and certainty. Consequently, the disk presser and/or the trader directly supply the substrate of the optical disk to the supplier without ordering destruction of the data of the disk to a professional waste disposer, thereby enabling a cost reduction for recycling the optical disk.

The method may further include a step of recovering gold from the powder collected by the powder collecting means.

According to this method, gold as well as plastic is recycled.

The method may further include a step of breaking the plastic substrate into pellets.

The plastic broken into pellets is readily delivered and recovered, so as to recycle the optical disk efficiently.

Another aspect of the present invention is to provide a recycling system for recycling an optical disk made of a plastic substrate sequentially laminated with a recording layer and a reflecting layer by a raw material supplier of the substrate and a disk presser who manufactures the optical disk, and optionally a trader who purchases the optical disk from the disk presser, including a raw material manufacturing device for manufacturing the raw material for the substrate by the raw material supplier of the substrate, an optical disk manufacturing device for manufacturing the optical disk by the disk presser by forming the substrate from the raw material for the substrate and laminating the substrate sequentially with the recording layer and the reflecting layer, an information recording device for recording predetermined information on the optical disk by one selected from the disk presser and the trader having purchased the disk from the disk presser, and a recovery device for recovering a pure and lucent plastic substrate without any material constituting the recording layer and the reflecting layer by one having recorded the predetermined information on the disk by abrading a disk fallen into disuse by means of an abrader from the reflecting layer side without supplying water so as to break the material away from the substrate and into powder while collecting the powder by a means for collecting powder.

According to this system, the method for recycling the optical disk described above is performed with ease and certainty, thereby reducing cost for recycling the optical disk.

### BRIEF DESCRIPTION OF THE DRAWINGS

FIG. 1 is a schematic diagram showing an entire structure of a recycling system that is an embodiment of the present invention;

FIG. 2 is a schematic front view of a substrate recovery device of FIG. 1;

FIG. 3 is a schematic side view of the recovery device;

FIG. 4 is a partly sectional side view of an abrader and a disk holder of the recovery device;

FIG. 5A is a schematic top view of an optical disk housing;

FIG. 5B is a schematic top view of a substrate housing;

FIG. 6 is a top view of a supporting plate of disk shape;

FIG. 7A is a partially enlarged sectional view of an optical disk;

FIG. 7B is an enlarged sectional view of a substrate of an optical disk; and

FIG. 8 is a flow chart showing an operation of the recycling system of FIG. 1.

### DESCRIPTION OF THE PREFERRED EMBODIMENTS

[Entire Structure of a Recycling System]

Now, a preferred embodiment of the present invention will be described below, making reference to the accompanying drawings.

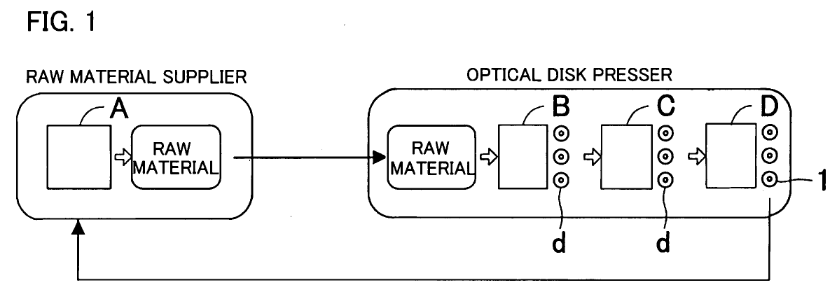

FIG. 1 is a schematic diagram showing an entire structure of a recycling system of an optical disk, which system is an embodiment of the present invention.

Referring to FIG. 1, the numeral (I) denotes a raw material supplier of a plastic substrate 1 for the optical disk (d), the numeral (II) denotes an optical disk presser who manufactures the optical disk (d) from the raw material for the substrate 1, the numeral (A) denotes a raw material manufacturing device for the substrate provided at a predetermined place such as a plant of the supplier (I), and the numerals (B), (C), and (D) respectively denote an optical disk manufacturing device, an information recording device, and a substrate recovery device provided at a predetermined place such as a plant of the presser (II).

The raw material manufacturing device (A) manufactures raw material (e.g. polycarbonate resin) for the substrate 1, which raw material is supplied to the disk presser (II). The manufacturing device (A) is a known device and is not limited particularly. Further, the manufacturing device (A) may be one device or may be composed of a plurality of devices.

The optical disk manufacturing device (B) manufactures the optical disk (d) by forming the substrate 1 from the raw material for the substrate 1 and laminating the substrate 1 sequentially with the recording layer 2 and the reflecting layer 3. The manufacturing device (B) is a known device and is not limited particularly. Further, the manufacturing device (B) may be one device or may be composed of a plurality of devices.

The information recording device (B) records predetermined information such as music information, game information, and picture information on the optical disk (d). The disks (d) on which the predetermined information are recorded are shipped to predetermined shops such as CD shops and personal computer shops as CD-ROMs and the like. The information recording device (B) is a known device and is not limited particularly. Further, the information recording device (B) may be one device or may be composed of a plurality of devices.

The substrate recovery device (D), as described below, recovers a pure and lucent plastic substrate 1 without any material constituting the recording layer 2 and the reflecting layer 3 by abrading a disk (d) fallen into disuse by means of an abrader 20 from the reflecting layer 3 side without supplying water so as to break the material away from the substrate 1 and into powder while collecting the powder by a means 30 for collecting powder, which substrate is supplied by the disk presser (II) to the raw material supplier (I).

[Substrate Recovery Device]

Now, a structure of the substrate recovery device (D) is described in detail below.

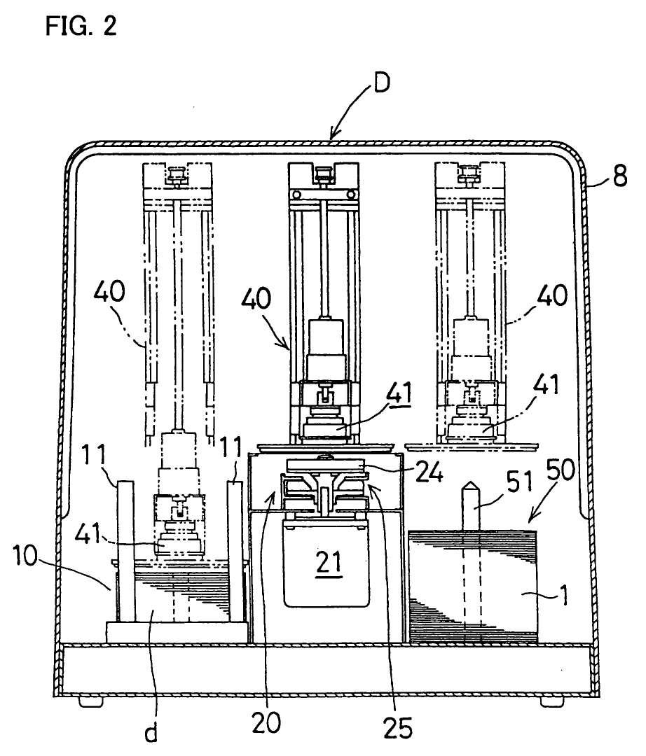

Referring to FIG. 2, the recovery device (D), which is accommodated in a container box 8 having substantially the same size as a microwave oven for household use, includes at front lower part of the box 8 an optical disk housing 10 for accommodating a number of optical disks (d), an abrader 20 for abrading the optical disk (d), and a substrate housing 50 for accommodating plastic substrates 1 from each of which a recording layer 2 and a reflecting layer 3 are broken away. The box 8 has at its front face an openable and closable lid 9 pivoting up and down, which is lifted up so as to open the front face of the box 8 for accommodating the optical disks (d) into the optical disk housing 10 and for recovering the substrates 1.

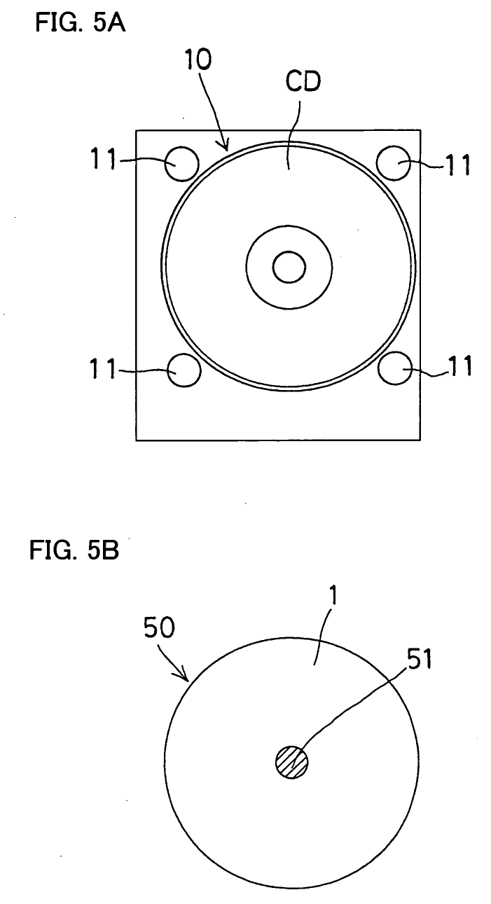

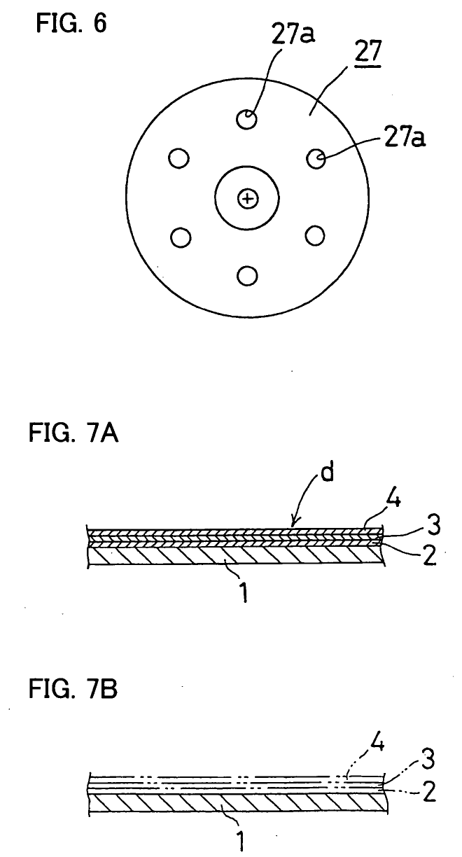

In the optical disk housing 10, as shown in FIG. 5A, positioning columns 11, 11 contactable with an outer circumference of the disk (d) stand at even intervals so as to orderly pile up a number of disks (d). The positioning columns 11, 11 are arranged in such a way as contacting with the outer circumference of the disk (d) so as to allow downward movement of a disk holder 41 of a conveyor 40 described below. The disks (d) are, herein, accommodated in the disk housing 10 with the substrate 1 side up.

In the substrate housing 50, a substrate holding column 51 insertable in central holes of the substrates 1 stands at its center. The substrate 1 abraded by the abrader 20 to break the recording layer 2 and the reflecting member 3 away is conveyed by the conveyer 40 to be fallen from above, so that the substrate holding column 51 is inserted in the central hole to hold the substrate 1. The substrate holding column 51 has a conical top tip, thereby making it relatively easy to be inserted into the central hole of the substrate 1.

The abrader 20 has a pair of driving motors 21, 21, abrading members 24, 24 rotated by the motors 21, 21, a supporting plate 22 on which the motors 21, 21 being hung, and a pair of rotating shafts 21 a, 21 a each projecting upward from downside of the supporting plate 22. A supporting column 23 is arranged to project from the center of the supporting plate 22 so as to have a hub 23a to fit in the central hole of the disk (d). The position where the hub 23a fits in the central hole of the disk (d) is an abrading position 29.

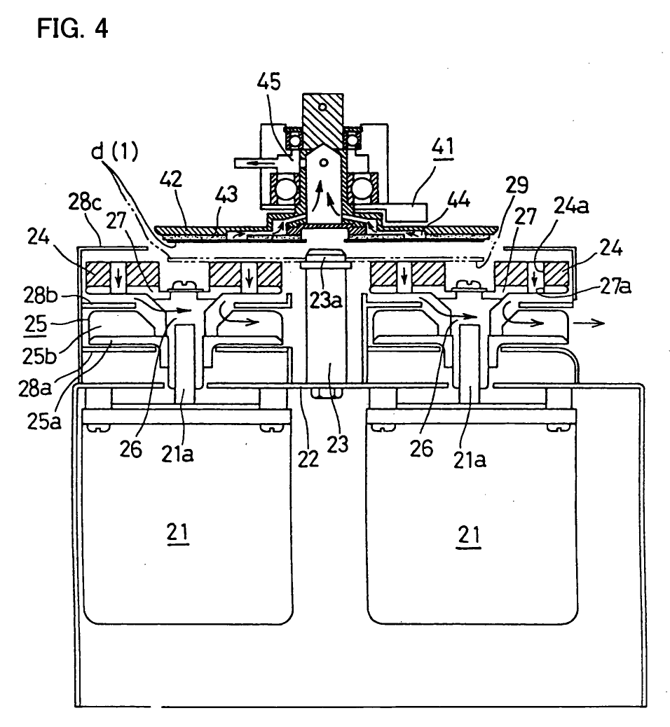

One rotating shaft 21a of the motor 21 is provided with one abrading member 24 of disk shape and an agitating rotor plate 25 by a fixing sleeve 26. The abrading member 24, as shown in FIG. 4, is mounted detachably on a disk-shaped supporting plate 27 provided integral with a top edge of the sleeve 26. The abrading member 24 and the supporting plate 27 each have a plurality of through-holes 24a, 24a and 27a , 27a in a longitudinal direction at positions corresponding to each other, through which the powder broken away from the disk (d) falls downward. The agitating rotor plate 25 provided below the supporting plate 27 has a plurality of blades 25b, 25b projecting from a top surface of a base 25a. Agitation of air above the rotor plate 25 operatively associated with rotation of the motor 21 directs the powder falling from the though-holes 24a, 24a and 27a, 27a of the abrading means 24 and the supporting plate 27, which lie above, to a cavity 31, thereby efficiently collecting the powder by means of a powder collecting means 30. Powder antiscattering walls 28a and 28b for preventing the powder from dispersing are provided above and below the rotor plate 25, while a powder antiscattering wall 28c is provided slightly obliquely above a periphery of the abrading position 29 as well.

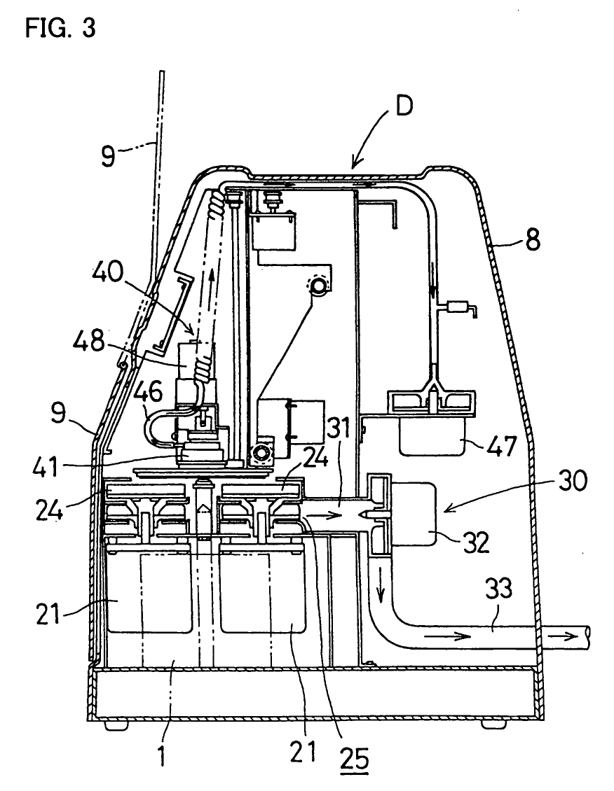

The powder collecting means 30, as shown in FIG. 3, includes the cavity 31 formed at a side of the rotor plate 25, a vacuum pump 32 provided on a head of the cavity 31, a discharging pipe 33 for discharging the introduced powder outside the box 8. The discharging pipe 33 is connected to a powder collecting container (not shown) outside the box.

The conveyor 40 conveys the optical disk (d) from the optical disk housing 10 to the abrading position 29, and also the substrate 1 from the abrading position 29 to the substrate housing 50, including the disk holder 41 for holding the disk (d) and the substrate 1. The disk holder 41 is moved from right to left or up and down so as to perform the conveyance.

The disk holder 41 includes a holder board 42 on its bottom, a rubber plate 43 adhered to the surface of the holder board 42 and adapted to be in close contact with the substrate 1, and an air duct 45 communicating with an air hole 44 formed on the rubber plate 43 and the holder board 42. The air duct 45 is connected to an intake pipe 46, which is further connected to a vacuum pump 47 at its distal end. Operation of the vacuum pump 47 produces a vacuum between the substrate 1 and the rubber plate 43, thereby enabling suction of the disk (d) or the substrate 1 onto the rubber plate 43. The disk holder 41 itself is rotated horizontally with its speed reduced by a geared motor 48. Referring to FIG. 3, the disk holder is located over the abrading position 29, whereas, it is actually located over the disk housing 10 or the substrate housing 50 before operation of the recovery device (D).

Now, a preferred method for use of the substrate recovery device (I) is described in detail below. First, the lid 9 of the container box 8 is opened to accommodate a number of optical disks (d), (d) having data to be destroyed in the optical disk housing 10 in such a manner that the disks (d), (d) are dropped into a space encircled by the positioning columns 11, 11, 11, 11 with the plastic substrate 1 side up, so that the disks (d), (d) are automatically piled up in order.

Next, when the lid 9 is closed and a switch is turned on to operate the conveyor 40, the disk holder 41 located over the disk housing 10 is moved downward, so that the rubber plate 43 contacts with the highest optical disk (d). At that time, or before that, the vacuum pump 47 of the conveyor 40 operates to suck one highest disk (d) onto the disk holder 41. When the disk (d) is firmly stuck to the disk holder 41, the disk holder 41 is moved to a position over the abrader 20 and the disk (d) as well. FIGS. 2 and 3 show that state described above. Gradual downward movement of the disk holder 41 from that level engages the central hole of the disk (d) with the hub 23a of the supporting column 23, thereby lightly pressing the disk (d) on the abrading members 24, 24. Then, the abrading members 24, 24 driven by the motors 21, 21 of the abrader 20 rotate to abrade a protecting layer 4, the reflecting layer 3, and then the recording layer 2 so as to break the raw material constituting each layer away from the substrate 1 and into powder.

The powder formed by the abrasion is agitated at the same time as falling downward through the through-holes 24a and 27a of the abrading members 24 and the disk-shaped supporting plate 27, sucked by the powder collecting means 30, and collected in the powder collecting container provided outside. As to the powder collected in the container, in the case of CD-Rs, the metal constituting the reflecting layer is gold, so the gold is also recovered relatively readily by a proper separate processing.

Completion of the abrasion of predetermined thickness makes the disk holder 41 to move up to an upper position with the substrate 1 held so as to disengage the central hole of the substrate 1 from the hub 23a of the supporting column. The disk holder 41, as shown in FIG. 3, needs only to move upward to lie slightly above the antiscattering wall 28c above the abrading means 24.

Subsequently, the disk holder 41 horizontally moves from the upper position to a position over the substrate housing 50 with the substrate 1 held until the central hole of the substrate 1 lies just over the substrate holding column 51, and then the disk holder 41 commences to move downward and halts the downward movement at the moment when the central hole of the substrate 1 approaches the top end of the substrate holding column 51, while the vacuum pump 47 of the conveyor 40 halts so as to stop suction of the substrate 1 by the disk holder 41, so that the substrate 1 is fallen down from the disk holder 41 as to insert the substrate holding column 51 in the central hole by relative movement with the result that the substrate 1 is accommodated in the substrate housing 50. This is a series of operations of the substrate recovery device (I) to recover a plastic substrate 1 from one optical disk (d).

After completion of recovery of a substrate 1 from one disk (d) in this way, the disk holder 41 moves upward to a position movable horizontally, and then moves horizontally toward a position over the disk housing 10. When the disk holder 41 reaches over the disk housing 10, again, downward movement of the disk holder 41, suction of a disk, and so on, that is, a series of operations described above for recovery of a pure and lucent plastic substrate made by breaking away the recording layer 2 and the reflecting layer 3 from one optical disk (d) are performed, and afterward, these series of operations are repeated until one bottom disk (d) accommodated in the disk housing 10.

As described above, the recovery device (d) abrades an optical disk (d) from the reflecting layer 3 side so as to break the reflecting layer 3 and the recording layer 2 away from the substrate 1 and into powder, thereby destroying data and recovering a pure substrate automatically once for all.

[Method for Recycling an Optical Disk]

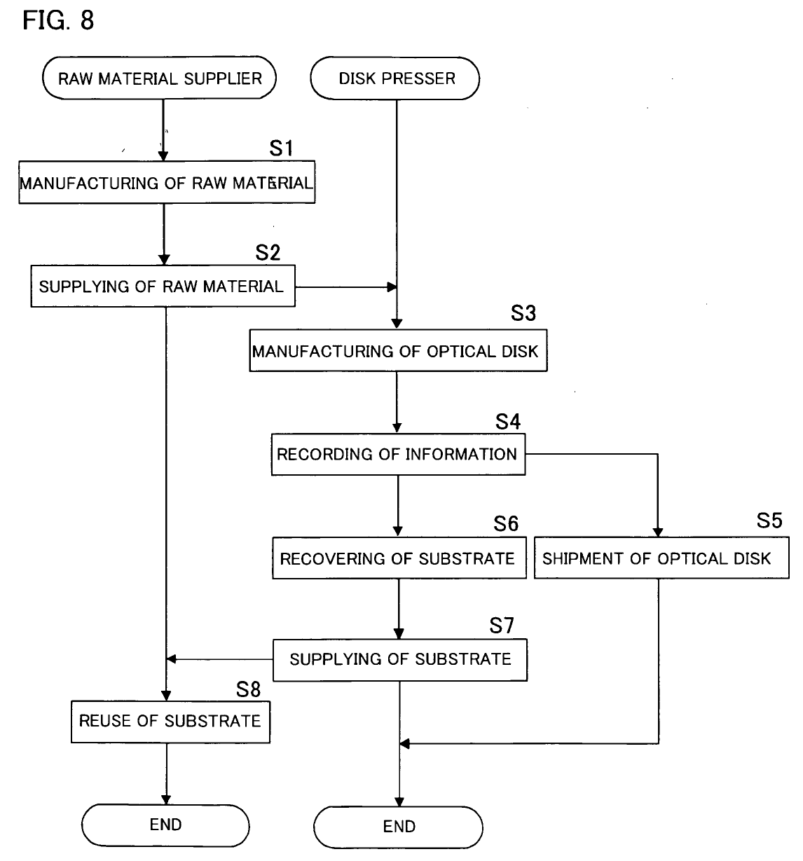

Now, a preferred method for recycling an optical disk by the recycling system described above is described below, making reference to FIG. 8. In the description below and the drawing, a “step” is hereinafter referred to as “S” for short.

The raw material supplier (I) manufactures the raw material for the plastic substrate 1 by means of the raw material manufacturing device (A) (S1), which raw material is supplied to the optical disk presser (II) (S2).

Herein, instead of manufacturing the raw material for the substrate 1, the supplier (I) may procure the raw material for the substrate 1 such as polycarbonate and supply it to the disk presser (II) as it is.

The disk presser (II) manufactures the substrate 1 from the raw material for the substrate 1 by means of the optical disk manufacturing device (B), and afterwards, manufactures an optical disk by laminating the substrate 1 sequentially with the recording layer 2 and the reflecting layer 3 (S3).

The disk presser (II) records predetermined information such as music information, game information, and picture information by means of the information recording device (B) on the disks (d) (S4), and ships the disks (d) to predetermined shops such as CD shops or computer shops as CD-ROMs and the like (S5).

When predetermined information is recorded on an optical disk (d) by means of the information recording device (B), recording of incomplete or miswritten information is frequently caused. Such an optical disk (d) falls into disuse for the disk presser (II), however the substrate 1 can be used by the raw material supplier (I), so it is likely to need to recycle the disused optical disk (d).

For that purpose, the disk presser (II) recovers a pure and lucent plastic substrate 1 without any material constituting the recording layer 2 and the reflecting layer 3 by abrading the disk (d) fallen into disuse by the abrader 20 from the reflecting layer 3 side without supplying water so as to break the material away from the substrate 1 and into powder while collecting the powder by the powder collecting means 30 by means of the substrate recovery device (D) (S6).

Then, the disk presser (II) supplies the substrate 1 recovered by the process of S6 to the raw material supplier (I) (S7).

The supplier (I) reuses the plastic substrate 1 supplied from the disk presser (II) for reproducing plastic products such as a ball point pen or a casing for a personal computer as well as the plastic substrate 1 of the optical disk (S8).

Herein, instead of directly supplying the plastic substrate 1 to the supplier 1, the presser (II) may supply the substrate 1 with some predetermined process such as breaking into pellets in advance.

According to the method, if having recorded incomplete or miswritten information on the disk (d), the disk presser (II) and/or the trader having purchased the disk from the presser (II) destroy the data of the disk (d) and recover the pure substrate 1 directly by the substrate recovery device (D) with ease and certainty. Consequently, they directly supply the substrate of the optical disk (d) to the supplier (I) without ordering destruction of the data of the disk (d) to a professional waste disposer, thereby enabling a cost reduction for recycling the optical disk (d).

In the preferred embodiment, although the disk presser (II) records predetermined information on an optical disk (d) by means of the information recording device (B) and recovers a plastic substrate 1 from a disused optical disk (d) by means of the substrate recovery device (D), an ordinary trader who purchased an optical disk with no recorded information by the presser (II) may perform those processing.

### INDUSTRIAL APPLICABILITY

The present invention is a method available for recycling a plastic portion of an optical disk in the broad sense of the term including not only CD-R, CD-ROM, or the like but also a so-called magnetic optical disk.

1. A method for recycling an optical disk made of a plastic substrate sequentially laminated with a recording layer and a reflecting layer by a raw material supplier of the substrate and a disk presser who manufactures the optical disk, and optionally a trader who purchases the optical disk from the disk presser, comprising the steps of:
one selected from steps consisting of (1) procuring raw material for the substrate and (2) manufacturing the raw material by means of a raw material manufacturing device and by the raw material supplier of the substrate;
manufacturing the optical disk by means of an optical disk manufacturing device and by the disk presser by forming the substrate from the raw material for the substrate and laminating the substrate sequentially with the recording layer and the reflecting layer; recording predetermined information on the optical disk by means of an information recording device and by one selected from the disk presser and the trader having purchased the disk from the presser; and
recovering a pure and lucent plastic substrate without any material constituting the recording layer and the reflecting layer by means of a substrate recovery device and by one having recorded the predetermined information on the disk by abrading a disk fallen into disuse by means of an abrader from the reflecting layer side without supplying water so as to break the material away from the substrate and into powder while collecting the powder by a means for collecting powder.

2. The method as defined in claim 1, further comprising a step of recovering gold from the powder collected by the powder collecting means.

3. The method as defined in claim 1, further comprising a step of breaking the plastic substrate into pellets.

4. A recycling system for recycling an optical disk made of a plastic substrate sequentially laminated with a recording layer and a reflecting layer by a raw material supplier of the substrate and a disk presser who manufactures the optical disk, and optionally a trader who purchases the optical disk from the disk presser, comprising: a raw material manufacturing device for manufacturing the raw material for the substrate by the raw material supplier of the substrate; an optical disk manufacturing device for manufacturing the optical disk by the disk presser by forming the substrate from the raw material for the substrate and laminating the substrate sequentially with the recording layer and the reflecting layer;
an information recording device for recording predetermined information on the optical disk by one selected from the disk presser and the trader having purchased the disk from the disk presser; and
a recovery device for recovering a pure and lucent plastic substrate without any material constituting the recording layer and the reflecting layer by one having recorded the predetermined information on the disk by abrading a disk fallen into disuse by means of an abrader from the reflecting layer side without supplying water so as to break the material away from the substrate and into powder while collecting the powder by a means for collecting powder.

5. The method as defined in claim 2, further comprising a step of breaking the plastic substrate into pellets.
